(19) United States
(12) Patent Application Publication
(10) Pub. No.: US 2025/0334520 A1
(43) Pub. Date: Oct. 30, 2025

(54) LAMP LIGHTING DEVICE, FLUORESCENCE DETECTOR AND CHROMATOGRAPH

(71) Applicant: SHIMADZU CORPORATION, Kyoto (JP)

(72) Inventor: Naoki YASUDA, Kyoto (JP)

(73) Assignee: SHIMADZU CORPORATION, Kyoto (JP)

(21) Appl. No.: 18/725,756

(22) PCT Filed: Dec. 22, 2022
(86) PCT No.: PCT/JP2022/047483

§ 371 Date: Nov. 22, 2024

(30) Foreign Application Priority Data
Jan. 5, 2022 (JP) 2022-000764

(51) Int. Cl. G01N 21/64; G01N 30/74; H05B 41/26

(52) U.S. Cl. CPC G01N 21/645; G01N 30/74; H05B 41/26; G01N 2021/6463; G01N 2201/06166

(57) ABSTRACT

A lamp lighting device is used to light a discharge lamp provided as a light source in a fluorescence detector. The discharge lamp has a configuration in which an anode and a cathode are arranged to be opposite to each other in a discharge container. The lamp lighting device includes a lamp driver, a lamp-voltage detector and a deterioration determiner. The lamp driver drives the discharge lamp. The lamp-voltage detector detects a lamp voltage in a monitoring period until a discharge state reaches a predetermined stable state after a discharge lamp in an unlit state is lit due to electrical breakdown. The deterioration determiner determines a deterioration state of the discharge lamp based on a detected lamp voltage.

### TECHNICAL FIELD

The present invention relates to a lamp lighting device for lighting a discharge lamp used in a fluorescence detector, a fluorescence detector and a chromatograph.

### BACKGROUND ART

In a liquid chromatograph, a fluorescence detector, for example, is used as a detector for detecting separated sample components (see Patent Document 1, for example). In the fluorescence detector, a light source that generates excitation light to be emitted to a sample is provided. The light source generates light having a specific wavelength that functions as excitation light. A discharge lamp such as a xenon lamp is used as a light source of the fluorescence detector.

[Patent Document 1] JP 2008-256530 A

### SUMMARY OF INVENTION

### Technical Problem

The above-mentioned discharge lamp has the configuration in which an anode and a cathode are arranged to be opposite to each other in a discharge container, for example. For such a discharge lamp, a warranty period of time and a warranty count with which the discharge lamp works stably under a predetermined condition are normally set. Based on the actual accumulated lighting period of time, the actual lighting count of the discharge lamp, the warranty period of time and the warranty count, for example, the user can determine whether the discharge lamp provided in the fluorescence detector needs to be replaced.

Specifically, the user attaches an unused discharge lamp to the fluorescence detector, for example, and records the date and time of attachment. Further, in regard to the discharge lamp the attachment date and time of which are recorded, the user records the lighting period of time and counts the number of times the discharge lamp is lit each time fluorescence detector is used. Thus, based on the recorded date and time of attachment, the recorded lighting period of time and the recorded lighting count, the user can determine whether the discharge lamp needs to be replaced. However, when a human error occurs in recording the date and time of attachment, the lighting period of time and the lighting count, it is not possible to appropriately determine whether the discharge lamp needs to be replaced.

In addition to the above-mentioned example, it is considered that the user can determine whether the discharge lamp needs to be replaced by viewing the discharge lamp in the lit state. However, the lit state of the discharge lamp does not change abruptly when the accumulated lighting period of time exceeds the warranty period of time and when the lighting count exceeds the warranty count. Unless the brightness of the discharge lamp is significantly reduced or the discharge lamp is blinking, the user cannot identify deterioration of the discharge lamp. The significant reduction in brightness of the discharge lamp and blinking of the discharge lamp may occur when the accumulated lighting period of time largely exceeds the warranty period of time, and the lighting count largely exceeds the warranty count. Therefore, the user cannot appropriately determine whether the discharge lamp needs to be replaced only by viewing the discharge lamp.

An object of the present invention is to provide a lamp lighting device, a fluorescence detector and a chromatograph that enable appropriate determination in regard to whether a discharge lamp needs to be replaced.

### Solution to Problem

A first aspect of the present invention relates to a lamp lighting device for a discharge lamp, with the lamp lighting device being provided as a light source in a fluorescence detector, wherein the discharge lamp has a configuration in which an anode and a cathode are arranged to be opposite to each other in a discharge container, and the lamp lighting device includes a lamp driver that drives the discharge lamp, a lamp-voltage detector that detects a voltage between the anode and the cathode as a lamp voltage in a monitoring period until a discharge state between the anode and the cathode reaches a predetermined stable state after the discharge lamp in an unlit state due to driving of the lamp driver is lit by electrical breakdown between the anode and cathode, and a deterioration determiner that determines a deterioration state of the discharge lamp based on a lamp voltage detected by the lamp-voltage detector.

A second aspect of the present invention relates to a fluorescence detector, including the lamp lighting device according to a first aspect, an optical system that guides light generated by the lamp lighting device as excitation light, and a light receiver that detects an intensity of fluorescence by receiving fluorescence generated from the sample.

A third aspect of the present invention relates to a chromatograph including a sample introducer that introduces a sample into an analysis flow path through which a mobile phase flows, a separation column that separates a sample that has been introduced into the analysis flow path by the sample introducer into components, and a detector for detecting sample components into which a sample has been separated by the separation column, wherein the detector includes the fluorescence detector according to a second aspect.

### Advantageous Effects of Invention

With the present invention, it is possible to appropriately determine whether a discharge lamp needs to be replaced.

### BRIEF DESCRIPTION OF THE DRAWINGS

FIG. 1 is a block diagram showing one example of the configuration of a lamp lighting device according to a first embodiment.

FIG. 2 is a diagram showing one example of a lamp-voltage waveform obtained when an unused lamp in an unlit state is lit.

FIG. 3 is a diagram showing one example of a lamp-voltage waveform obtained when a depleted lamp in an unlit state is lit.

FIG. 4 is a flowchart of a lamp lighting process according to the first embodiment.

FIG. 5 is a block diagram showing one example of the configuration of a lamp lighting device according to a second embodiment.

FIG. 6 is a flowchart of a lamp lighting process according to the second embodiment.

FIG. 7 is a block diagram showing one example of the configuration of a lamp lighting device according to a third embodiment.

FIG. 8 is a block diagram showing one example of the configuration of a fluorescence detector according to a fourth embodiment.

FIG. 9 is a diagram showing one example of the configuration of a liquid chromatograph according to a fifth embodiment.

### DESCRIPTION OF EMBODIMENTS

A lamp lighting device, a fluorescence detector and a chromatograph according to embodiments of the present invention will be described below with reference to the drawings.

### 1. First Embodiment

### <1> Configuration of Lamp Lighting Device

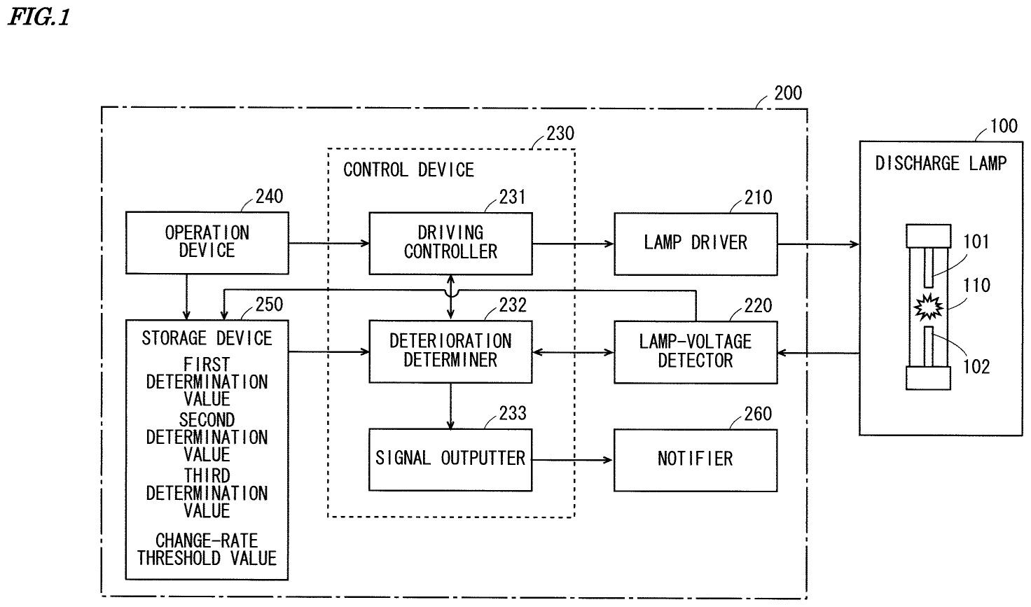

FIG. 1 is a block diagram showing one example of the configuration of a lamp lighting device according to a first embodiment. The lamp lighting device 200 according to the present embodiment is provided in a fluorescence detector and used to light a discharge lamp 100 that generates excitation light. The discharge lamp 100 includes an anode 101, a cathode 102 and a discharge container 110. A discharge medium is sealed in the discharge container 110. In the discharge container 110, the anode 101 and the cathode 102 are arranged to be opposite to each other while being spaced apart from each other. The discharge lamp 100 according to the present embodiment is a xenon lamp. In the xenon lamp, a xenon gas is sealed as a discharge medium in the discharge container 110. In the following description, a voltage generated between the anode 101 and the cathode 102 of the discharge lamp 100 is referred to as a lamp voltage.

As shown in FIG. 1, the lamp lighting device 200 includes a lamp driver 210, a lamp-voltage detector 220, a control device 230, an operation device 240, a storage device 250 and a notifier 260. The lamp driver 210 includes a circuit for applying a voltage to the discharge lamp 100, a circuit for adjusting a current flowing through the discharge lamp 100, and the like, and drives the discharge lamp 100 based on the control of the control device 230.

Specifically, the lamp driver 210 applies a starting voltage to the discharge lamp 100 in an unlit state, for example. Thus, in the discharge lamp 100, electrical breakdown occurs between the anode 101 and the cathode 102, and the discharge lamp 100 is lit.

Thereafter, the lamp driver 210 adjusts the current flowing between the anode 101 and the cathode 102, thereby driving the discharge lamp 100 such that the discharge between the anode 101 and the cathode 102 sequentially transitions to a glow discharge and an arc discharge. Thus, the discharge lamp 100 is maintained in a lit state. When the discharge lamp 100 is lit, light having a specific wavelength corresponding to the discharge medium (xenon in the present example) is generated by the discharge lamp 100.

In the following description, the period from the time when the discharge lamp 100 in the unlit state is lit due to electrical breakdown until the time when the discharge between the anode 101 and the cathode 102 reaches a stable state where the discharge is stably an arc discharge is referred to as a monitoring period. The stable state will be described below.

The lamp-voltage detector 220 detects a lamp voltage at a predetermined sampling cycle in the period during which the lamp lighting device 200 is powered on. The operation device 240 includes one or a plurality of switches, a keyboard, a pointing device and the like, and is configured to be operable by a user in order to provide an instruction for lighting and unlighting the discharge lamp 100, and the like. Further, the operation device 240 is configured to be operable by the user for input of various information used in a lamp lighting process, described below.

The storage device 250 stores various information received from the operation device 240, lamp voltages detected by the lamp-voltage detector 220, and the like. In FIG. 1, a first determination value, a second determination value, a third determination value and a change-rate threshold value are described as the information stored in the storage device 250. The first to third determination values are used for determination of a deterioration state of the discharge lamp 100, described below. The change-rate threshold value can be used to determine whether the discharge generated in the discharge lamp 100 is in the stable state.

The notifier 260 includes a display device, for example, and presents information relating to deterioration of the discharge lamp 100 to the user in response to a signal provided by the control device 230. The display device may be a display lamp including one or a plurality of LEDs (light emitting diodes) or a liquid crystal display device. Further, instead of the display device or in addition to the display device, the notifier 260 may include a sound output device such as a speaker.

The control device 230 includes a CPU (Central Processing Unit) and a memory, for example, and includes a driving controller 231, a deterioration determiner 232 and a signal outputter 233 as functions. A lamp lighting program is stored in the memory of the control device 230. The functions of the control device 230 are implemented by execution by the CPU of the lamp lighting program stored in the memory. Instead of the CPU and the memory, the control device 230 may include a microcomputer. Further, part or all of the plurality of functions of the CPU in the control device 230 may be implemented by hardware such as an electronic circuit.

Each function of the control device 230 will be described. The driving controller 231 controls the work of the lamp driver 210 in response to various instructions provided by the operation device 240. Further, the driving controller 231 controls the work of the lamp driver 210 based on various determination results provided by the deterioration determiner 232.

The deterioration determiner 232 determines a deterioration state of the discharge lamp 100 based on a lamp voltage detected by the lamp-voltage detector 220 in the monitoring period. Based on the determination result provided by the deterioration determiner 232, the signal outputter 233 outputs a signal indicating information in regard to deterioration of the discharge lamp 100 to the notifier 260.

### <2> Relationship Between Deterioration of Discharge Lamp 100 and Lamp-Voltage Waveform

In the following description, the discharge lamp 100 which has not been used is referred to as an unused lamp. Further, the discharge lamp 100 having an accumulated lighting period of time equal to a warranty period of time and having a lighting count equal to a warranty count is referred to as a depleted lamp. Here, the warranty period of time is a period of time that is preset in regard to an accumulated lighting period of time of the discharge lamp 100, and is a period of time during which the discharge lamp 100 is warranted to work stably under a predetermined condition. Further, the warranty count is a count that is present in regard to the lighting count of the discharge lamp 100, and is a count by which the discharge lamp 100 is warranted to work stably under a predetermined condition.

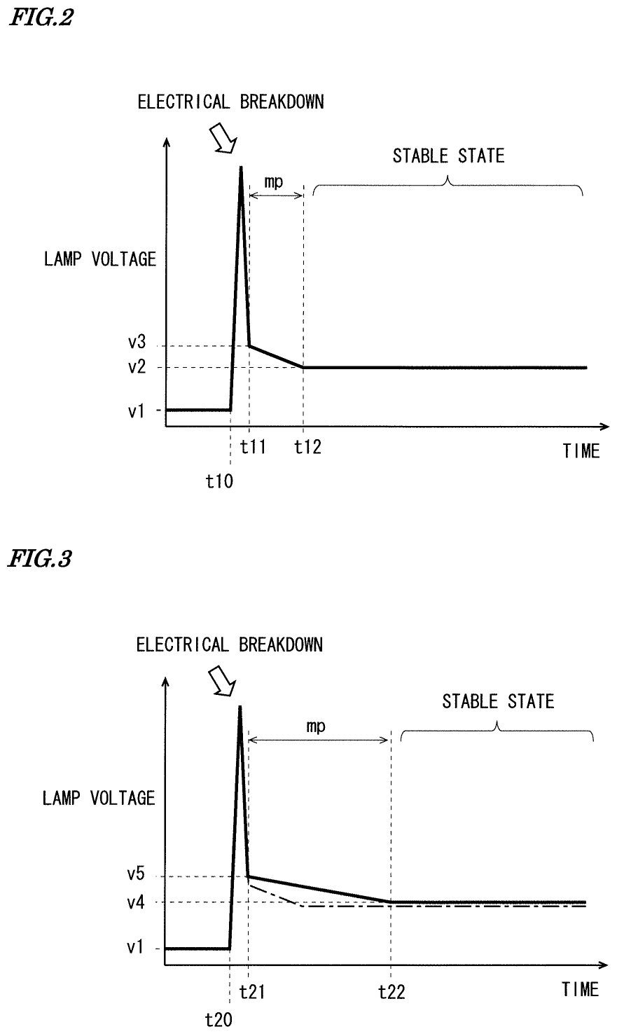

FIG. 2 is a diagram showing one example of a lamp-voltage waveform obtained when an unused lamp in an unlit state is lit. In FIG. 2, the abscissa indicates time, and the ordinate indicates a lamp voltage. In the example of FIG. 2, when a starting voltage is applied to the unused lamp at a point t10 in time, the lamp voltage increases abruptly from an initial voltage value v1 (0 V, for example). Thus, discharge is started due to an occurrence of electrical breakdown, and the lamp voltage reaches a peak and then decreases to a voltage value v3 higher than the voltage value v1 at a point t11 in time. Thereafter, the lamp voltage decreases from the voltage value v3 at a substantially constant change rate, and reaches a voltage value v2 higher than the voltage value v1 and lower than the voltage value v3 at a point t12 in time. At this time, the discharge between the anode 101 and the cathode 102 is stably an arc discharge. Thus, after the point t12 in time, the discharge between the anode 101 and the cathode 102 is maintained in the stable state. In the present embodiment, the stable state refers to the discharge state in the discharge lamp 100 where an absolute value of a change amount per unit time of the lamp voltages is equal to or smaller than a predetermined change-rate threshold value. Alternatively, the stable state refers to the discharge state in the discharge lamp 100 where the lamp voltage is continuously in a predetermined stable determination range for a predetermined stable determination period of time. The change-rate threshold value and the stable determination range can be defined based on an experiment, simulation or the like in consideration of a noise or the like generated in the lamp voltage detected by the lamp-voltage detector 220.

FIG. 3 is a diagram showing one example of a lamp-voltage waveform obtained when a depleted lamp in an unlit state is lit. In FIG. 3, the abscissa indicates time, and the ordinate indicates a lamp voltage. Further, in FIG. 3, the lamp-voltage waveform obtained when the depleted lamp is lit is indicated by the thick solid line, and the lamp-voltage waveform obtained when the unused lamp in FIG. 2 is lit is indicated by the one-dot and dash line.

In the example of FIG. 3, similarly to the example of FIG. 2, when a starting voltage is applied to the depleted lamp at a point t20 in time, the lamp voltage increases abruptly from the initial voltage value v1 (0 V, for example). Thus, discharge is started due to electrical breakdown, and the lamp voltage reaches a peak value and then decreases to a voltage value v5 higher than the voltage value v1 at a point t21 in time. The voltage value v5 is higher than the above-mentioned voltage value v3. Thereafter, the lamp voltage decreases from the voltage value v5 at a substantially constant change rate, and reaches a voltage value v4 at a point t22 in time. The voltage value v4 is higher than the above-mentioned voltage value v2. At this time, the discharge between the anode 101 and the cathode 102 is stably an arc discharge. At the point t22 in time and after the point t22 in time, the discharge between the anode 101 and the cathode 102 is maintained in the stable state.

In the following description, in the examples of FIGS. 2 and 3, the respective points t11, t21 in time at which the lamp voltages decrease to the respective voltage values v3, v5 due to electrical breakdown are referred to as discharge start points in time. The lamp-voltage waveform obtained when the unused lamp is lit and the lamp-voltage waveform obtained when the depleted lamp is lit basically show the same change. However, in the examples of FIGS. 2 and 3, the lamp-voltage waveforms vary in the respective periods mp of time from the respective discharge start points t11, t21 in time to the respective points t12, t22 in time at which the lamp voltages are stabilized. The respective periods mp of time from the respective discharge start points t11, t21 in time to the respective points t12, t22 in time at which the lamp voltages are stabilized are monitoring periods.

Specifically, as shown in FIG. 3, the lamp voltage of the depleted lamp is higher than the lamp voltage of the unused lamp in the monitoring period mp. Further, as shown in FIGS. 2 and 3, the length of the monitoring period mp corresponding to the depleted lamp is larger than the length of the monitoring period mp corresponding to the unused lamp.

As a result of repeated various experiments and studies including the examples of FIGS. 2 and 3, the inventor of the present invention has obtained the finding that, in regard to the discharge lamp 100, the larger the accumulated lighting period of time and the larger the lighting count, the higher a lamp-voltage value in the stable state as compared to the unused lamp. According to such a correlation, it is considered that it is possible to determine a deterioration degree of the discharge lamp 100 by monitoring the lamp voltage of the discharge lamp 100 the discharge of which is in the stable state. However, in regard to the detected lamp-voltage value (the voltage value v2 of FIG. 2) of the unused lamp the discharge of which is in the stable state and the detected lamp-voltage value (the voltage value v4 of FIG. 3) of the depleted lamp the discharge of which is in the stable state, there is no difference between them to such extent that the deterioration degree of the discharge lamp 100 can be easily determined.

As such, as a result of more repeated various experiments and studies including the examples of FIGS. 2 and 3, the inventor of the present invention has obtained the finding that, in regard to the discharge lamp 100, the larger the accumulated lighting period of time and the larger the lighting count, the higher the lamp voltage in the monitoring period mp as compared to the unused lamp.

Further, the inventor of the present invention has obtained the finding that, in regard to the discharge lamp 100, the larger the accumulated lighting period of time and the larger the lighting count, the smaller a decrease amount per unit time of the lamp voltage in the monitoring period mp and the larger the monitoring period mp as compared to an unused lamp. That is, the inventor of the present invention has obtained the finding that, in regard to the discharge lamp 100, the higher a deterioration degree, the smaller a decrease amount per unit time of the lamp voltage in the monitoring period mp and the larger the monitoring period mp. In the present embodiment, in order to appropriately determine whether the discharge lamp 100 in the fluorescence detector needs to be replaced, the lamp lighting process, described below, is executed based on the above-mentioned findings.

### <3> Lamp Lighting Process

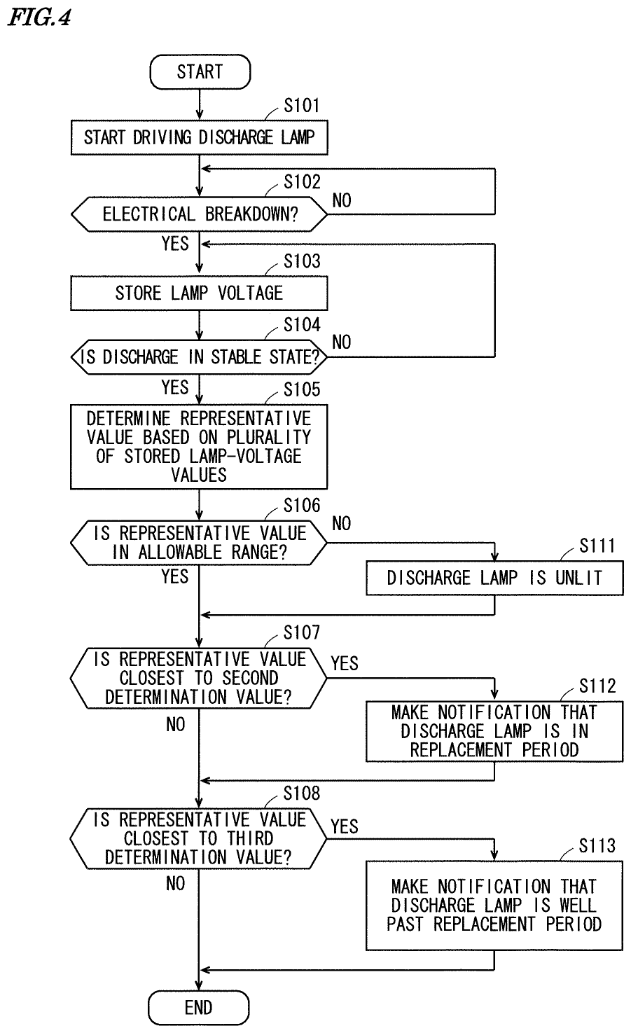

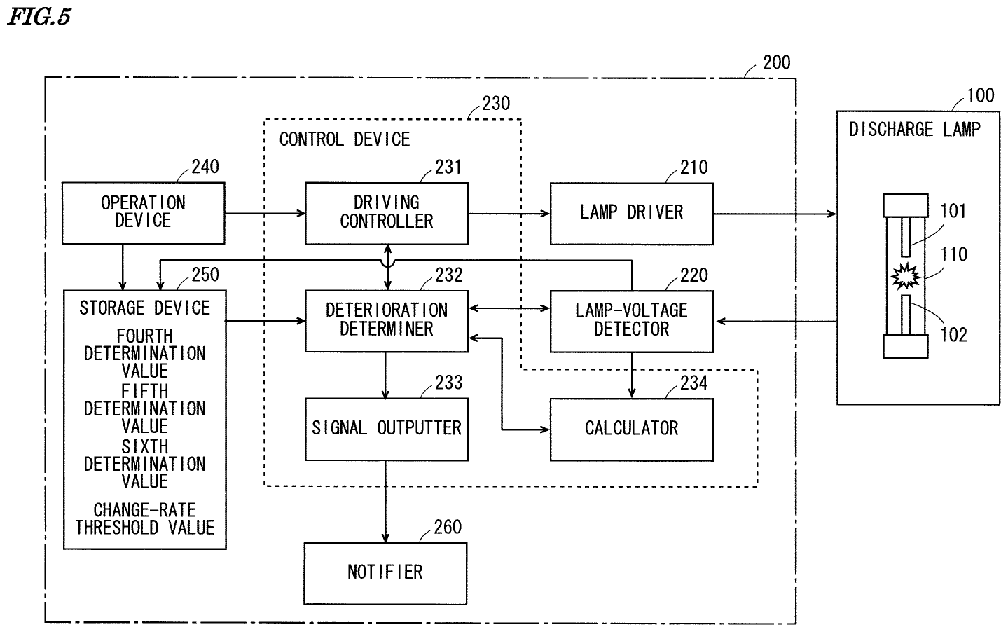

FIG. 4 is a flowchart of the lamp lighting period according to the first embodiment. By execution by the CPU of the control device 230 of FIG. 1 of the lamp lighting program stored in the memory, the lamp lighting process of FIG. 4 is repeatedly executed at a predetermined cycle in the period during which the lamp lighting device 200 is powered on and the period from the time when an instruction for lighting the discharge lamp 100 is provided until the time when the discharge between the anode 101 and cathode 102 is stabilized. In the lamp lighting device 200, an instruction for lighting the discharge lamp 100 is provided when the user operates the operation device 240 of FIG. 1, for example.

Here, as described above, at a start point in time of the lamp lighting process according to the present embodiment, the first determination value, the second determination value, the third determination value and the change-rate threshold value are stored in advance in the storage device 250 of FIG. 1. The first determination value, the second determination value and the third determination value will be described. In the following description, the discharge lamp 100 the accumulated lighting period of time of which largely exceeds the warranty period of time and the lighting count of which is sufficiently larger than the warranty count is referred to as a deteriorated lamp.

The first determination value is defined by usage of a plurality of unused sample lamps of the type same as that of the discharge lamp 100 to be subjected to the lamp lighting process. Specifically, each of the plurality of unused lamps is lit, and a lamp voltage is detected after a predetermined prescribed period of time (about 10 msec, for example) has elapsed from the discharge start point in time. Thereafter, the average value of the detected lamp voltages in regard to the plurality of unused lamps is calculated as the first determination value. The prescribed period of time is defined such that a point in time at which the prescribed period of time elapses from the discharge start point in time is in the monitoring period.

The second determination value is defined by usage of a plurality of depleted sample lamps of the type same as that of the discharge lamp to be subjected to the lamp lighting process. Specifically, each of the plurality of depleted lamps is lit, and a lamp voltage is detected after the above-mentioned prescribed period of time elapses from the discharge start point in time. Thereafter, the average value of the detected lamp voltages in regard to the plurality of depleted lamps is calculated as the second determination value.

The third determination value is defined by usage of a plurality of deteriorated lamps of the type same as that of the discharge lamp 100 to be subjected to the lamp lighting process. Specifically, each of the plurality of deteriorated lamps is lit, and a lamp voltage is detected after the above-mentioned prescribed period of time elapses from the discharge start point in time. Thereafter, the average value of the detected lamp voltages in regard to the plurality of deteriorated lamps is calculated as the third determination value.

As shown in FIG. 4, when the lamp lighting process is started, the driving controller 231 controls the lamp driver 210 such that the lamp driver 210 starts driving for lighting the discharge lamp 100 (step S101). Next, based on a lamp voltage detected by the lamp-voltage detector 220, the deterioration determiner 232 determines whether electrical breakdown has occurred (step S102). The determination in the step S102 is made based on detection of a value of current flowing through the discharge lamp 100 at a predetermined cycle, for example, and whether a current value equal to or larger than a predetermined value (several amperes, for example) is continuously detected in a predetermined period (several hundred milliseconds, for example) of time. Alternatively, the determination in the step S102 is made based on whether a detected lamp-voltage value is higher than a predetermined voltage value, for example. Alternatively, the determination in the step S102 is made based on whether a lamp-voltage value has changed abruptly at a change rate higher than a predetermined change rate, for example. The step S102 is repeated until electrical breakdown occurs.

When electrical breakdown occurs, the deterioration determiner 232 causes the memory of the control device 120 to sequentially store the lamp-voltage values detected by the lamp-voltage detector 220 at the predetermined sampling cycle together with information about the detection points in time (step S103). The information about the detection point in time includes a period of time elapsed since the occurrence of electrical breakdown or the number of times a lamp voltage is detected since the occurrence of electrical breakdown.

Subsequently, based on the plurality of sequentially stored lamp-voltage values and the above-mentioned change-rate threshold value, the deterioration determiner 232 determines whether the discharge between the anode 101 and the cathode 102 is in the stable state (step S104). Specifically, based on the plurality of lamp-voltage values sequentially stored in the step S103, the deterioration determiner 232 calculates a change amount per unit time of the lamp voltages. Further, in a case in which an absolute value of the calculated change amount per unit time of the lamp voltages is larger than the change-rate threshold value, the deterioration determiner 232 determines that the discharge is not in the stable state. On the other hand, in a case in which an absolute value of the calculated change amount per unit time of the lamp voltages is equal to or smaller than the change-rate threshold value, the deterioration determiner 232 determines that the discharge is in the stable state.

In addition to the above-mentioned example, when determination is made in regard to whether the discharge is in the stable state, the deterioration determiner 232 may make determination based on whether a lamp-voltage value detected at a point in time closest to the current point in time is equal to or larger than a predetermined stable reference value. Specifically, in a case in which an absolute value of the calculated change amount per unit time of the lamp voltages is equal to or smaller than the change-rate threshold value, and a lamp-voltage value detected at a point in time closest to the current point in time is equal to or larger than the predetermined stable reference value, the deterioration determiner 232 may determine that the discharge is in the stable state. In this case, the stable reference value is set to a value that is half of a rated voltage that is defined in advance for the discharge lamp 100, for example, and is stored in advance in the storage device 250. With this determination method, in a case in which the discharge lamp 100 is unlit because a stable arc discharge is not generated after an occurrence of electrical breakdown, it prevents erroneous determination that the discharge is in the stable state.

In the step S104, in a case in which the discharge generated in the discharge lamp 100 is not in the stable state, that is, the discharge is in the monitoring period, the deterioration determiner 232 returns to the step S103. On the other hand, when the discharge generated in the discharge lamp 100 is stabilized, the deterioration determiner 232 determines a representative value based on a plurality of lamp-voltage values stored in the step S103 (step S105). At this time, the deterioration determiner 232 stops recording of lamp-voltage values.

In the present embodiment, the representative value is a lamp-voltage value stored at a point in time at which the above-mentioned prescribed period of time elapses since an occurrence of electrical breakdown or a point in time around that point in time, among the plurality of lamp-voltage values stored in the step S103.

As described above, the first determination value is a lamp-voltage value corresponding to the unused lamp, and the second determination value is a lamp-voltage value corresponding to the depleted lamp. Further, as described above, the lamp-voltage value of the discharge lamp 100 increases as the accumulated lighting period of time increases. Therefore, in a case in which the representative value is in the range of not less than the first determination value and not more than the second determination value, it is considered that the deterioration degree of the discharge lamp 100 has not reached the degree at which replacement is required. In the present embodiment, the representative-value range of not less than the first determination value and not more than the second determination value is referred to as an allowable range. On the other hand, in a case in which the representative value is outside of the allowable range, it is considered that the deterioration degree of the discharge lamp 100 has reached a degree at which replacement is required.

As such, after the step S105, the deterioration determiner 232 determines whether the determined representative value is in the allowable range (step S106). In a case in which the representative value is not in the allowable range, the driving controller 231 controls the lamp driver 210 such that the discharge lamp 100 is unlit (step S111).

In a case in which the representative value is in the allowable range in the step S106 or after the step S111, the deterioration determiner 232 determines whether the representative value is closest to the second determination value among the first to third determination values (step S107).

As described above, the second determination value is a lamp-voltage value corresponding to the depleted lamp. As such, in a case in which the representative value is closest to the second determination value, the signal outputter 233 provides, to the notifier 260, a notification signal indicating that the discharge lamp 100 is in a replacement period (step S112).

In the S107, the deterioration determiner 232 may determine whether the representative value is in a predetermined range including the second determination value. The predetermined range including the second determination value is smaller than ½ of the allowable range defined for the lamp voltage. In this case, when the representative value is in the predetermined range including the second determination value, the signal outputter 233 provides, to the notifier 260, a notification signal indicating that the discharge lamp 100 is in the replacement period. Thus, the notifier 260 presents, to the user through the display device or the sound output device, the notification representing that the discharge lamp 100 is in the replacement period.

In a case in which the representative value is not closest to the second determination value in the step S107, or after the step S112, the deterioration determiner 232 determines whether the representative value is closest to the third determination value among the first to third determination values (step S107).

As described above, the third determination value is a lamp-voltage value corresponding to the deteriorated lamp. As such, in a case in which the representative value is closest to the third determination value, the signal outputter 233 provides, to the notifier 260, a notification signal indicating that the discharge lamp 100 is well past the replacement period (step S113).

In a case in which determining in the step S107 whether the representative value is in the predetermined range including the second determination value, the deterioration determiner 232 may determine in the step S108 whether the representative value is in another range including the third determination value. In this case, the other range including the third determination value is the range that does not overlap with any of the above-mentioned allowable range or the predetermined range including the second determination value. When the representative value is in the other range including the third determination value, the signal outputter 233 provides, to the notifier 260, a notification signal indicating that the discharge lamp 100 is well past the replacement period. Thus, the notifier 260 presents, to the user through the display device or the sound output device, the notification representing that the discharge lamp 100 is well past the replacement period.

In a case in which the representative value is not closest to the third determination value in the step S108, or after the step S113, the lamp lighting process ends. In the above-mentioned lamp lighting process, the steps S106 and S111 may be executed after either one of the steps S107 and S112, or may be executed after either one of the steps S108 and S113. Further, the steps S106 and S111 do not have to be executed.

Further, in the above-mentioned lamp lighting process, the steps S107 and S112 may be executed before either one of the steps S106 and S111, or may be executed after either one of the steps S108 and S113. Further, the steps S107 and S112 do not have to be executed.

Further, in the above-mentioned lamp lighting process, the steps S108 and S113 may be executed before either one of the steps S106 and S111, or may be executed before either one of the steps S107 and S112. Further, the steps S108 and S113 do not have to be executed.

### <4> Effects

(a) In the above-mentioned lamp lighting device 200, the deterioration state of the discharge lamp 100 is determined based on lamp-voltage values detected in the monitoring period. Specifically, the deterioration degree of the discharge lamp 100 is determined based on the relative relationship between a lamp-voltage value detected in the monitoring period mp and one or a plurality of determination values defined according to the deterioration state of the discharge lamp 100. The user is also notified of a determination result. Thus, the user can easily and appropriately identify whether the discharge lamp 100 in the fluorescence detector needs to be replaced.

(b) With the above-mentioned configuration, the deterioration state of the discharge lamp 100 is determined based on a lamp voltage of the discharge lamp 100. Therefore, the deterioration state of the discharge lamp 100 the accumulated lighting period time and the lighting count of which are unknown is also appropriately determined.

(c) In the above-mentioned lamp lighting device 200, a representative value is determined based on a lamp voltage detected in the lamp lighting process. When the representative value is not in the allowable range, the discharge lamp 100 is unlit. This prevents damage to the discharge lamp 100 due to continuous use of the discharge lamp 100 the deterioration state of which has progressed. Further, in the fluorescence detector including the above-mentioned lamp lighting device 200, a decrease in detection accuracy of fluorescence due to the use of the discharge lamp 100 the deterioration state of which has progressed is suppressed.

(d) In the above-mentioned lamp lighting device 200, in a case in which a representative value is close to the second determination value, the notification indicating that the discharge lamp 100 is in the replacement period is presented to the user. In a case in which a representative value is close to the third determination value, the notification indicating that the discharge lamp 100 is well past the replacement period is presented to the user. Thus, the user can easily and appropriately identify whether the discharge lamp 100 needs to be replaced.

### 2. Second Embodiment

In regard to a lamp lighting device 200 according to a second embodiment, the differences from the lamp lighting device 200 according to the first embodiment will be described. FIG. 5 is a block diagram showing one example of the configuration of the lamp lighting device according to the second embodiment. As shown in FIG. 5, in the lamp lighting device 200 according to the present embodiment, the control device 230 further includes a calculator 234 as a function in addition to the driving controller 231, the deterioration determiner 232 and the signal outputter 233. Similarly to other functions, the calculator 234 is implemented by execution of the lamp lighting program stored in the memory by the CPU of the control device 230. Part or all of the calculator 234 may be realized by hardware such as an electronic circuit.

The calculator 234 calculates the difference value between a lamp voltage detected after a predetermined prescribed period of time elapses from a discharge start point in time and a lamp voltage detected when the discharge state in the discharge lamp 100 is in the stable state, and provides the calculated difference value to the deterioration determiner 232. As such, the deterioration determiner 232 determines the deterioration state of the discharge lamp 100 based on the difference value provided by the calculator 234.

Also in the lamp lighting device 200 according to the present embodiment, a lamp lighting process is repeatedly executed at a predetermined cycle in the period during which the lamp lighting device 200 is powered on and the discharge between an anode 101 and a cathode 102 is stabilized after an instruction for lighting the discharge lamp 100 is provided. Here, the storage device 250 according to the present embodiment stores a fourth determination value, a fifth determination value and a sixth determination value instead of the first determination value, the second determination value and the third determination value according to the first embodiment.

The fourth determination value is defined by usage of a plurality of unused sample lamps of the type same as that of the discharge lamp 100 to be subjected to the lamp lighting process. Specifically, each of the plurality of unused lamps is lit, and a lamp voltage is detected after a prescribed period of time (about 10 msec, for example) has elapsed from a discharge start point in time. Further, in regard to each unused lamp, a lamp voltage is detected after the discharge state in the unused lamp has transitioned to the stable state. Thereafter, in regard to each of the plurality of unused lamps, the difference value between a lamp voltage detected after the prescribed period of time has elapsed from the discharge start point in time and a lamp voltage detected when the discharge state in the unused lamp is in the stable state is calculated. That is, the difference value between the lamp voltages detected at two points of time before and after the end of the monitoring period is calculated. Finally, the average value of the plurality of difference values calculated in regard to the plurality of unused lamps is calculated as the fourth determination value.

The fifth determination value is determined by usage of a plurality of depleted sample lamps of the type same as that of the discharge lamp 100 to be subjected to the lamp lighting process. Specifically, each of the plurality of depleted lamps is lit, and a lamp voltage is detected after the above-mentioned prescribed period of time elapses from the discharge start point in time. Further, in regard to each depleted lamp, a lamp voltage is detected after the discharge state in the depleted lamp has transitioned to the stable state. Thereafter, in regard to each of the plurality of depleted lamps, the difference value between a lamp voltage detected after the prescribed period of time has elapsed from the discharge start point in time and a lamp voltage detected when the discharge state in the depleted lamp is in the stable state. That is, the difference value between the lamp voltages detected at two points of time before and after the end of the monitoring period is calculated. Finally, the average value of the plurality of difference values calculated in regard to the plurality of depleted lamps is calculated as the fifth determination value.

The sixth determination value is determined by usage of a plurality of deteriorated sample lamps of the type same as that of the discharge lamp 100 to be subjected to the lamp lighting process. Specifically, each of the plurality of deteriorated lamps is lit, and a lamp voltage is detected after the above-mentioned prescribed period of time elapses from the discharge start point in time. Further, in regard to each deteriorated lamp, a lamp voltage is detected after the discharge state in the deteriorated lamp has transitioned to the stable state. Thereafter, in regard to each of the plurality of deteriorated lamps, the difference value between a lamp voltage detected after the prescribed period of time has elapsed from the discharge start point in time and a lamp voltage detected when the discharge state in the deteriorated lamp is in the stable state. That is, the difference value between the lamp voltages detected at two points of time before and after the end of the monitoring period is calculated. Finally, the average value of the plurality of difference values calculated in regard to the plurality of deteriorated lamps is calculated as the sixth determination value.

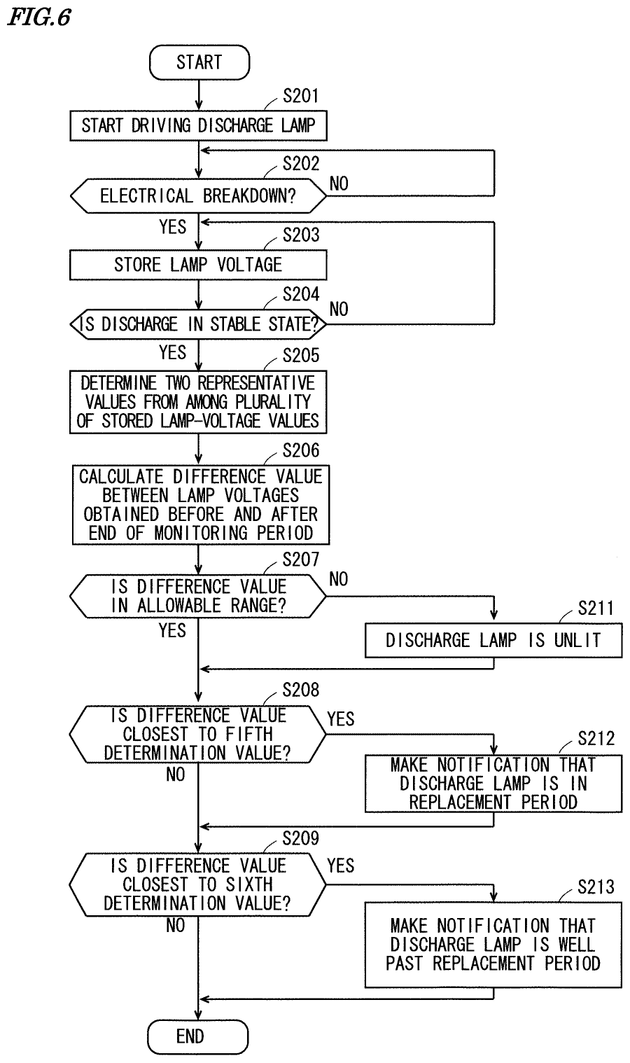

The lamp lighting process according to the second embodiment executed by the CPU of the control device 230 of FIG. 5 will be described below. FIG. 6 is a flowchart of the lamp lighting process according to the second embodiment.

As shown in FIG. 6, in the lamp lighting process according to the second embodiment, as in the first embodiment, control of the start of driving of the discharge lamp 100 (step S201) and determination of whether electrical breakdown has occurred (step S202) are sequentially carried out. In a case in which it is determined that electrical breakdown has occurred, lamp-voltage values detected at a predetermined sampling cycle are sequentially stored in the memory of the control device 230 together with information about the detection point in time (step S203). Further, based on the plurality of sequentially stored lamp-voltage values and the change-rate threshold value stored in advance in the storage device 250, whether the discharge between the anode 101 and the cathode 102 is in the stable state is determined (step S204). At this time, similarly to the first embodiment, whether the discharge is in the stable state may be determined based on a stable reference value in addition to the plurality of above-mentioned lamp-voltage values and the change-rate threshold value.

In a case in which it is determined that the discharge is in the stable state, the deterioration determiner 232 determines two representative values based on the plurality of lamp-voltage values stored in the step S203 (step S205). At this time, the deterioration determiner 232 stops recording of lamp-voltage values.

In the present embodiment, one of the two representative values is a lamp-voltage value stored at a point in time at which the above-mentioned prescribed period of time elapses since an occurrence of electrical breakdown or a point in time around that point in time, among the plurality of lamp-voltage values stored in the step S203. The other one of the two representative values is a lamp-voltage value obtained when the discharge state in the discharge lamp 100 is in the stable state, among the plurality of lamp-voltage values stored in the step S203.

Next, based on the two determined representative values, the calculator 234 calculates the difference value between the lamp voltages obtained before and after the end of the monitoring period (step S206). As described above, the fourth determination value is the difference value between the lamp voltages corresponding to the unused lamps, and the fifth determination value is the difference value between the lamp voltages corresponding to the depleted lamps. Further, as described above, the lamp-voltage value of the discharge lamp 100 increases as the accumulated lighting period of time increases. In other words, the difference value between lamp voltages of the discharge lamp 100 increases as the accumulated lighting period of time increases.

Therefore, in a case in which the difference value between lamp voltages of the discharge lamp 100 is in the range of not less than the fourth determination value and not more than the fifth determination value, it is considered that the deterioration degree of the discharge lamp 100 has not reached a degree at which replacement is required. In the present embodiment, the difference-value range of not less than the fourth determination value and not more than the fifth determination value is referred to as an allowable range. On the other hand, in a case in which the difference value is outside of the allowable range, it is considered that the deterioration degree of the discharge lamp 100 has reached a degree at which replacement is required.

As such, after the step S206, the deterioration determiner 232 determines whether the calculated difference value is in the allowable range (step S207). In a case in which the difference value is not in the allowable range, the driving controller 231 controls the lamp driver 210 such that the discharge lamp 100 is unlit (step S211).

In a case in which the difference value is in the allowable range in the step S207 or after the step S211, the deterioration determiner 232 determines whether the difference value is closest to the fifth determination value among the fourth to sixth determination values (step S208).

As described above, the fifth determination value is the difference value between the lamp voltages corresponding to the depleted lamps. As such, in a case in which the difference value is closest to the fifth determination value, the signal outputter 233 provides, to the notifier 260, a notification signal indicating that the discharge lamp 100 is in the replacement period (step S212).

In the step S208, the deterioration determiner 232 may determine whether the difference value is in a predetermined range including the fifth determination value. The predetermined range including the fifth determination value is smaller than ½ of the allowable range defined for the difference value between the lamp voltages. In this case, when the difference value is in the predetermined range including the fifth determination value, the signal outputter 233 provides, to the notifier 260, a notification signal indicating that the discharge lamp 100 is in the replacement period. Thus, the notifier 260 presents, to the user through the display device or the sound output device, the notification representing that the discharge lamp 100 is in the replacement period.

In a case in which the difference value is not closest to the fifth determination value or after the step S212, the deterioration determiner 232 determines whether the difference value is closest to the sixth determination value among the fourth to sixth determination values (step S209).

As described above, the sixth determination value is the difference value between the lamp voltages corresponding to the depleted lamp. As such, in a case in which the difference value is closest to the sixth determination value, the signal outputter 233 provides, to the notifier 260, a notification signal indicating that the discharge lamp 100 is well past the replacement period (step S213).

In a case in which determining in the step S208 whether the difference value is in the predetermined range including the fifth determination value, the deterioration determiner 232 may determine in the step S209 whether the difference value is in another range including the sixth determination value. In this case, the other range including the sixth determination value is the range that does not overlap with any of the above-mentioned allowable range or the predetermined range including the sixth determination value. When the difference value is in the other range including the sixth determination value, the signal outputter 233 provides, to the notifier 260, a notification signal indicating that the discharge lamp 100 is well past the replacement period. Thus, the notifier 260 presents, to the user through the display device or the sound output device, the notification representing that the discharge lamp 100 is well past the replacement period.

In a case in which the difference value is not closest to the sixth determination value in the step S209, or after the step S213, the lamp lighting process ends. In the above-mentioned lamp lighting process, the steps S207 and S211 may be executed after either one of the steps S208 and S212, or may be executed after either one of the steps S209 and S213. Further, the steps S207 and S211 do not have to be executed.

Further, in the above-mentioned lamp lighting process, the steps S208 and S212 may be executed before either one of the steps S207 and S211, or may be executed after either one of the steps S209 and S213. Further, the steps S208 and S212 do not have to be executed.

Further, in the above-mentioned lamp lighting process, the steps S209 and S213 may be executed before either one of the steps S207 and S211, or may be executed before either one of the steps S208 and S212. Further, the steps S209 and S213 do not have to be executed.

In the above-mentioned lamp lighting device 200, a difference value is calculated based on a lamp voltage detected in the monitoring period and a lamp voltage detected when the discharge state in the discharge lamp 100 is in the stable state. Further, the deterioration state of the discharge lamp 100 is determined based on the calculated difference value. The difference value between lamp voltages is acquired based on the temporal change in characteristics of the discharge lamp 100 which is to be subjected to calculation of the difference values. Thus, with the method of determining a deterioration state based on a difference value, an error in regard to a determination result caused by an individual difference in characteristics of the discharge lamp 100 is less likely to occur in the determination result. That is, the accuracy for determination of deterioration of the discharge lamp 100 is improved. As a result, the user can appropriately identify whether the discharge lamp 100 in the fluorescence detector needs to be replaced.

### 3. Third Embodiment

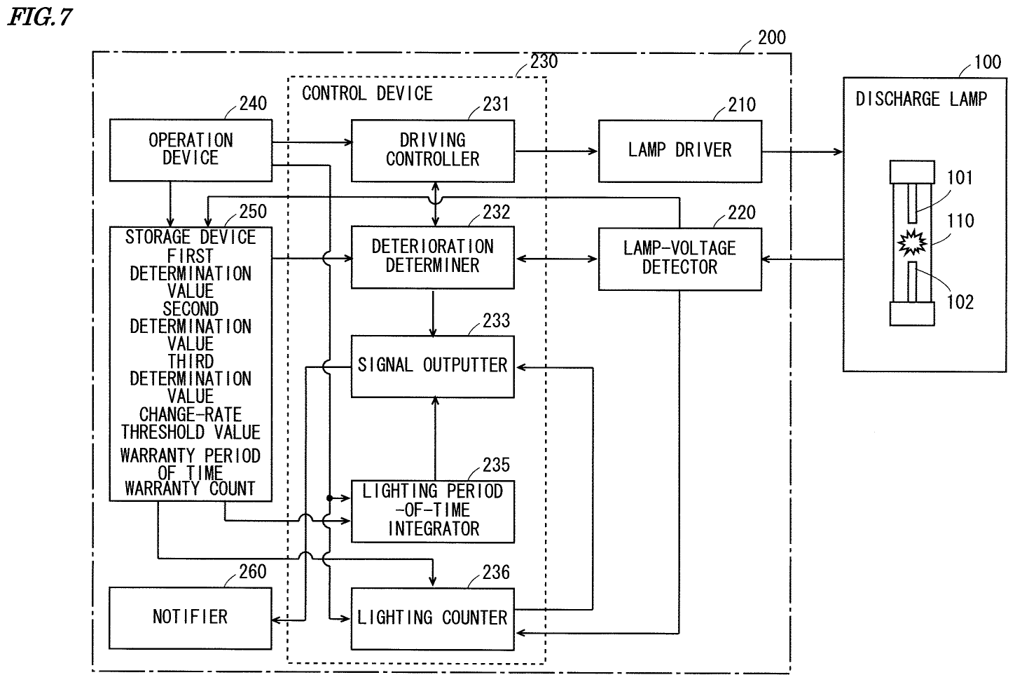

In regard to a lamp lighting device 200 according to a third embodiment, the differences from the lamp lighting device 200 according to the first embodiment will be described. FIG. 7 is a block diagram showing one example of the configuration of the lamp lighting device according to the third embodiment. As shown in FIG. 7, in the lamp lighting device 200 according to the present embodiment, a control device 230 further includes a lighting period-of-time accumulator 235 and a lighting counter 236 as functions in addition to the driving controller 231, the deterioration determiner 232 and the signal outputter 233. Similarly to other functions, the lighting period-of-time accumulator 235 and the lighting counter 236 are implemented by execution by the CPU of the control device 230 of a lamp lighting program stored in the memory. Part or all of the lighting period-of-time accumulator 235 and the lighting counter 236 may be realized by hardware such as an electronic circuit.

In the lamp lighting device 200 of FIG. 7, when an instruction for lighting a discharge lamp 100 is provided, an operation device 240 is operated by the user, and the lighting instruction is provided to the control device 230. Further, when an instruction for unlighting the discharge lamp 100 is provided, the operation device 240 is operated by the user, and the unlighting instruction is provided to the control device 230. Further, when the discharge lamp 100 to be lit is replaced, the user operates the operation device 240, and a replacement signal indicating that an unused lamp has been attached is provided to the control device 230.

Based on the lighting instruction and the unlighting instruction provided by the operation device 240, the lighting period-of-time accumulator 235 accumulates the lighting periods of time of the discharge lamp 100. Further, in a case in which the replacement signal provided by the operation device 240 is received, the lighting period-of-time accumulator 235 resets the accumulated value for the lighting periods of time (accumulated lighting period of time).

Based on a lighting instruction and an unlighting instruction provided by the operation device 240, the lighting counter 236 counts the number of times the discharge lamp 100 is lit. Further, in a case in which receiving a replacement signal provided by the operation device 240, the lighting counter 236 resets the counted value (lighting count).

The storage device 250 according to the present embodiment stores a warranty period of time and a warranty count in addition to the first determination value, the second determination value, the third determination value and the change-rate threshold value. Thus, in a case in which the accumulated lighting period of time reaches the warranty period of time, the lighting time accumulator 235 provides, to the signal outputter 233, a signal indicating that the accumulated lighting period of time has reached the warranty period of time. Further, in a case in which the counted number of times (lighting count) reaches the warranty count, the lighting counter 236 provides, to the signal outputter 233, a signal indicating that the lighting count has reached the warranty count.

In a case in which receiving at least one of the signal indicating that the accumulated lighting period of time has reached the warranty period of time and the signal indicating that the lighting count has reached the warranty count, the signal outputter 233 provides, to the notifier 260, a notification signal indicating that the discharge lamp 100 is in the replacement period. Thus, the notification representing that the discharge lamp 100 is in the replacement period is provided to the user through the display device or the sound output device.

In the present embodiment, the deterioration state of the discharge lamp 100 is determined based on the accumulated lighting period of time and the lighting count of the discharge lamp 100 in addition to a lamp voltage of the discharge lamp 100. Therefore, reliability of determination for deterioration of the discharge lamp 100 is improved.

### 4. Fourth Embodiment

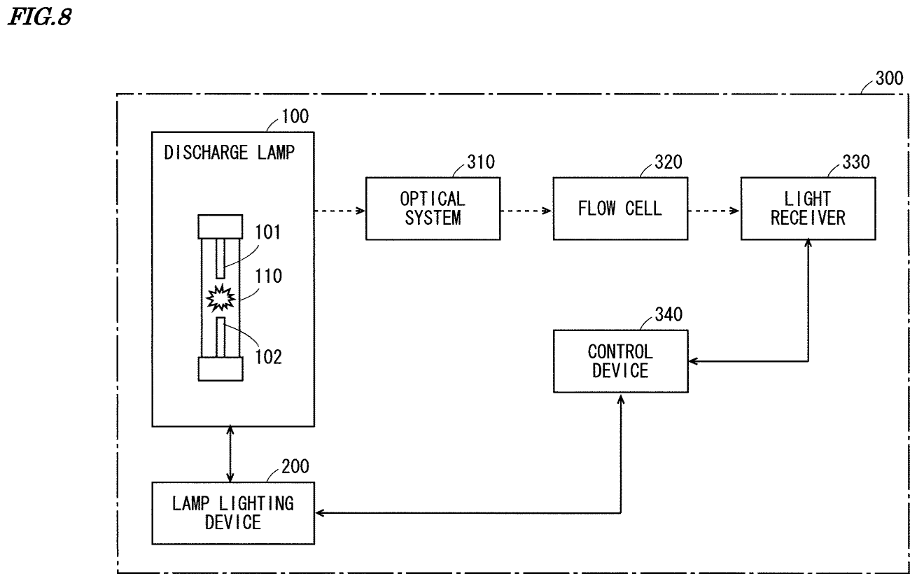

FIG. 8 is a block diagram showing one example of the configuration of a fluorescence detector according to a fourth embodiment. As shown in FIG. 8, the fluorescence detector 300 according to the present embodiment includes a discharge lamp 100, the lamp lighting device 200 according to any one of the first to third embodiments, an optical system 310, a flow cell 320, a light receiver 330 and a control device 340.

In the fluorescence detector 300, the discharge lamp 100 in an unlit state is switched to a lit state by the lamp lighting device 200, so that light having a specific wavelength is generated by the discharge lamp 100. Light generated by the discharge lamp 100 is guided to the flow cell 320 as excitation light by the optical system 310. A mobile phase and a sample supplied from an analysis column (separation column) of a liquid chromatograph, for example, flows into the flow cell 320. A sample flowing through the flow cell 320 is irradiated with excitation light, so that fluorescence is generated from the sample. The fluorescence generated from the sample is guided to the light receiver 330. The light receiver 330 includes a photodiode, for example, and detects an intensity of the incident fluorescence. The intensity of light detected by the light receiver 330 is equivalent to an amount of light received by the light receiver 330.

The control device 340 includes a CPU and a memory, for example, and mainly controls the work of the lamp lighting device 200 and the light receiver 330. The control device 340 lights or unlights the discharge lamp 100 by controlling the lamp lighting device 200 based on the operation using an operation unit (not shown) performed by the user. Further, the operation device 240 stores or outputs the intensity of fluorescence output from the light receiver 330 as a detection result.

As described above, the fluorescence detector 300 according to the present embodiment includes the lamp lighting device 200 according to any one of the first to third embodiments. With the above-mentioned lamp lighting device 200, it is possible to appropriately determine whether the discharge lamp 100 in the fluorescence detector 300 needs to be replaced. Therefore, because the discharge lamp 100 can be appropriately replaced, a decrease in accuracy for detection of fluorescence due to continuous use of the deteriorated discharge lamp 100 is suppressed.

### 5. Fifth Embodiment

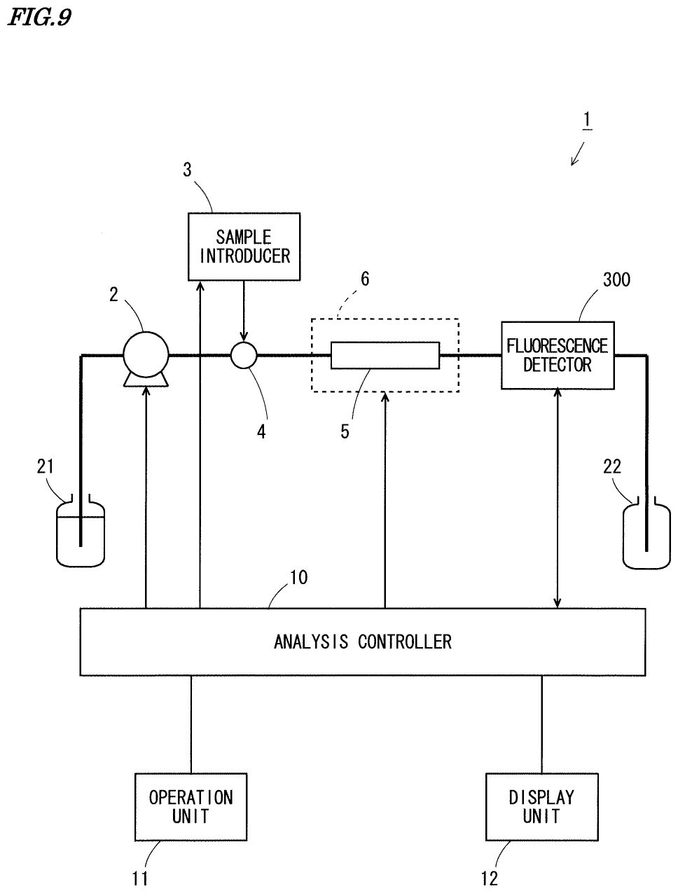

FIG. 9 is a diagram showing one example of the configuration of a liquid chromatograph according to a fifth embodiment. As shown in FIG. 9, the liquid chromatograph 1 according to the present embodiment includes a pump 2 for a mobile phase, a sample introducer 3, an introduction port 4, an analysis column 5, a column oven 6 and the fluorescence detector 300 according to the fourth embodiment. The analysis column 5 is provided in the column oven 6. The column oven 6 maintains the temperature of the analysis column 5 at a set temperature.

The pump 2 sucks a mobile phase (eluent) in a mobile phase container 21 and supplies the mobile phase to the analysis column 5. The sample introducer 3 includes an autosampler or an injector, for example, and introduces a sample to be analyzed into the mobile phase in the introduction port 4. The mobile phase and the sample that have passed through the analysis column 5 flow through the flow cell 320 (see FIG. 8) of the fluorescence detector 300 and is discharged to a liquid waste container 22.

The liquid chromatograph 1 includes an analysis controller 10, an operation unit 11 and a display 12. The operation unit 11 is used by a user to provide various instructions to the analysis controller 10. The analysis controller 10 controls the pump 2, the sample introducer 3, the column oven 6 and the fluorescence detector 300. Further, the analysis controller 10 generates a chromatogram based on an output signal of the fluorescence detector 300. The generated chromatogram is displayed in the display 12.

With the fluorescence detector 300 according to the fourth embodiment, a decrease in accuracy for detection of fluorescence due to continuous use of the deteriorated discharge lamp 100 is suppressed. This suppresses a decrease in accuracy for detection of a sample caused by the discharge lamp 100 in the liquid chromatograph 1.

### 6. Other Embodiments

(a) In the lamp lighting device 200 according to the first and second embodiments, a change-rate threshold value is stored in the storage device 250. Further, based on the stored change-rate threshold value, it is determined whether the discharge between the anode 101 and the cathode 102 is in the stable state. However, the present invention is not limited to this. Instead of the change-rate threshold value, the storage device 250 may store the above-mentioned stable determination period of time and the above-mentioned stable determination range.

In this case, in the step S104 of FIG. 4 and the step S204 of FIG. 6, based on a plurality of sequentially stored lamp-voltage values, and the stable determination period of time and the stable determination range, the deterioration determiner 232 may determine whether the discharge between the anode 101 and the cathode 102 is in the stable state. Specifically, in a case in which the plurality of sequentially stored lamp-voltage values are not in the stable determination range continuously in the stable determination period of time, the deterioration determiner 232 may determine that the discharge is not in the stable state. On the other hand, in a case in which the plurality of sequentially stored lamp-voltage values are in the stable determination range continuously in the stable determination period of time, the deterioration determiner 232 may determine that the discharge is in the stable state.

(b) While the first determination value is calculated when each of a plurality of unused lamps is lit and a plurality of lamp voltages respectively detected after a prescribed period of time has elapsed from the discharge start point in time in regard to the plurality of unused lamps are averaged, the present invention is not limited to this.

A first determination value may be calculated as follows. For example, a plurality of lamp voltages are detected at a plurality of predetermined points in time or in a predetermined period during a monitoring period in regard to each of a plurality of unused sample lamps, and the average value of the plurality of detected lamp voltages is calculated as a detection average value. Thereafter, the plurality of detection average values calculated in regard to the plurality of unused lamps are further averaged, so that a first determination value is calculated. In a case in which a first determination value is calculated according to the present example, second and third determination values are also calculated by the same method as that for the first determination value.

Further, in a case in which first, second and third determination values are calculated according to the present example, a representative value is determined as described below, for example, in the lamp lighting process. In the step S105 of FIG. 4, the deterioration determiner 232 extracts a plurality of lamp voltages detected at a plurality of predetermined points in time or in a predetermined period during the monitoring period from among the plurality of lamp-voltage values stored in the step S103. Further, the deterioration determiner 232 determines the average value of the extracted plurality of lamp voltages as a representative value. A median value of the plurality of extracted lamp voltages may be determined as a representative value.

(c) A fourth determination value is calculated when the difference value between lamp voltages detected at two points in time before and after the end of the monitoring period in regard to each of a plurality of unused lamps is calculated and a plurality of difference values calculated in regard to the plurality of unused lamps are averaged. However, the present invention is not limited to this.

A fourth determination value may be calculated as follows. For example, a plurality of lamp voltages are detected at a plurality of predetermined points in time or in a predetermined period before end of the monitoring period in regard to each of a plurality of unused sample lamps, and the average value of the plurality of detected lamp voltages is calculated as a first detection average value. Further, a plurality of lamp voltages are detected at a plurality of predetermined points in time or in a predetermined period after the end of the monitoring period in regard to each of a plurality of unused sample lamps, and the average value of the plurality of detected lamp voltages is calculated as a second detection average value. Thereafter, the difference value between the first detection average value and the second detection average value calculated for each of the plurality of unused lamps is calculated. Finally, a fourth determination value is calculated when the plurality of difference values calculated in regard to a plurality of depleted lamps are averaged. In a case in which a fourth determination value is calculated according to the present example, fifth and sixth determination values are also calculated by the same method as that for the fourth determination value.

Further, in a case in which fourth, fifth and sixth determination values are calculated according to the present example, a representative value is determined as described below, for example, in the lamp lighting process. In the step S205 of FIG. 6, the deterioration determiner 232 extracts a plurality of lamp voltages detected at a plurality of predetermined points in time or in a predetermined period during the monitoring period from among the plurality of lamp-voltage values stored in the step S203. Further, the deterioration determiner 232 determines the average value of the plurality of extracted lamp voltages as one representative value. The median value of the plurality of extracted lamp voltages may be determined as one representative value.

Further, the deterioration determiner 232 extracts a plurality of lamp voltages detected at a plurality of predetermined points in time or in a predetermined period after the end of the monitoring period from among the plurality of lamp-voltage values stored in the step S203. Further, the deterioration determiner 232 determines the average value of the plurality of extracted lamp voltages as another representative value. The median value of the plurality of extracted lamp voltages may be determined as another representative value.

(d) First to sixth determination values may be determined in consideration of a noise component included in a lamp voltage detected by the lamp-voltage detector 220, or the like. For example, the values, obtained when a predetermined value is added to or subtracted from the values calculated when a plurality of sample discharge lamps are lit by the method described in the first and second embodiments, may be determined as first to six determination values.

(e) While the liquid chromatograph 1 is described as an example of the chromatograph according to the present invention in the fifth embodiment, the chromatograph according to the present invention may be another chromatograph such as a supercritical fluid chromatograph.

(f) In the lamp lighting devices 200 according to the first to fifth embodiments, the deterioration determiner 232 may determine the deterioration state of the discharge lamp 100 based on whether the length of the monitoring period exceeds a predetermined period of time, for example. Specifically, in a case in which the length of the monitoring period exceeds the predetermined period of time, the deterioration determiner 232 may determine that the discharge lamp 100 is deteriorated. Further, in a case in which the length of the monitoring period does not exceed the predetermined period of time, the deterioration determiner 232 may determine that the discharge lamp 100 is not deteriorated.

(g) In the lamp lighting devices 200 according to the first to fifth embodiments, the deterioration determiner 232 may determine the deterioration state of the discharge lamp 100 based on whether a change rate (absolute value of the change amount per unit time) of the lamp voltages in the monitoring period is lower than a predetermined change rate. Specifically, the deterioration determiner 232 may determine that the discharge lamp 100 is deteriorated in a case in which the change rate of the lamp voltages in the monitoring period is lower than a predetermined change rate. Further, in a case in which the change rate of the lamp voltages in the monitoring period is equal to or higher than the predetermined change rate, it may be determined that the discharge lamp 100 is not deteriorated.

### 6. Correspondences Between Constituent Elements in Claims and Parts in Preferred Embodiments

In the following paragraphs, non-limiting examples of correspondences between various elements recited in the claims below and those described above with respect to various preferred embodiments of the present invention are explained. As each of various elements recited in the claims, various other elements having configurations or functions described in the claims can be also used.

In the above-mentioned embodiment, the fluorescence detector 300 is an example of a fluorescence detector and a detector, the discharge lamp 100 is an example of a light source and a discharge lamp, the first determination value is an example of a first value, the second determination value is an example of a second example, and the third determination value is an example of a third value.

The storage device 250 is an example of a storage, the range of deterioration of the discharge lamp 100 being in the ideal replacement period is an example of a first range, the depleted lamp is an example of a sample discharge lamp satisfying a first deterioration condition, the range of deterioration of the discharge lamp 100 that is past the ideal replacement period is an example of a second range, the deteriorated lamp is an example of a sample discharge lamp satisfying a second deterioration condition, the fourth determination value is an example of a fourth value, the fifth determination value is an example of a fifth value, the sixth determination value is an example of a sixth value, and the analysis column 5 is an example of a separation column.

### 7. Aspects

The inventor of the present invention has repeated various experiments and studies in order to appropriately determine whether a discharge lamp provided as a light source in a fluorescence detector needs to be replaced. The inventor of the present invention has obtained the finding that the waveforms of lamp voltages in the period from the time when the discharge lamp in the unlit state is lit due to electrical breakdown until the time when the discharge between an anode and a cathode reaches the stable state vary according to the accumulated lighting periods of time of discharge lamps. Based on this finding, the inventor of the present invention has devised the following configuration. It is understood by those skilled in the art that the plurality of above-mentioned illustrative embodiments are specific examples of the below-mentioned aspects.

(Item 1) A lamp lighting device according to one aspect for a discharge lamp, with the lamp lighting device being provided as a light source in a fluorescence detector, wherein the discharge lamp has a configuration in which an anode and a cathode are arranged to be opposite to each other in a discharge container, and the lamp lighting device includes a lamp driver that drives the discharge lamp, a lamp-voltage detector that detects a voltage between the anode and the cathode as a lamp voltage in a monitoring period until a discharge state between the anode and the cathode reaches a predetermined stable state after the discharge lamp in an unlit state due to driving of the lamp driver is lit by electrical breakdown between the anode and cathode, and a deterioration determiner that determines a deterioration state of the discharge lamp based on a lamp voltage detected by the lamp-voltage detector.

In the lamp lighting device 200 according to item 1, the deterioration state of the discharge lamp is determined based on the lamp-voltage values detected in the monitoring period. In this case, it is possible to determine whether the discharge lamp is workable under a warranty condition. Thus, it is possible to appropriately determine whether the discharge lamp in the fluorescence detector needs to be replaced.

(Item 2) The lamp lighting device according to item 1, wherein the stable state may be a discharge state when an absolute value of a change amount per unit time of the lamp voltages is equal to or smaller than a predetermined change-rate threshold value or when the lamp voltage is continuously in a predetermined stable determination range in a predetermined stable determination period of time.

In this case, the monitoring period is the period until the absolute value of the change amount per unit time of the lamp voltages becomes equal to or smaller than the change-rate threshold value after the discharge lamp is lit due to electrical breakdown. Alternatively, the monitoring period is the period until the lamp voltages continuously fall in the predetermined stable determination range in the stable determination period of time after the discharge lamp is lit due to electrical breakdown.

(Item 3) The lamp lighting device according to item 1 or 2, may further include a storage that stores a first value and a second value larger than the first value, and a driving controller that controls work of the lamp driver, wherein the first value may be a value corresponding to a lamp voltage detected by the lamp-voltage detector when an unused sample discharge lamp is lit before detection of fluorescence by the fluorescence detector, the second value may be a value corresponding to a lamp voltage detected by the lamp-voltage detector when a sample discharge lamp satisfying a first deterioration condition is lit before detection of fluorescence by the fluorescence detector, with the first deterioration condition representing that a deterioration degree of a discharge lamp is in a predetermined first range, and the deterioration determiner may determine that, when a lamp-voltage value detected by the lamp-voltage detector is not less than the first value and not more than the second value at a time of detection of fluorescence by the fluorescence detector, a deterioration degree of the discharge lamp has not reached a degree at which replacement is required.

(Item 4) The lamp lighting device according to item 3, wherein the driving controller, in a case in which a lamp-voltage value detected by the lamp-voltage detector is not less than the first value and not more than the second value at a time of detection of fluorescence by the fluorescence detector, may allow the lamp driver to perform lighting work for the discharge lamp, and in a case in which a lamp-voltage value detected by the lamp-voltage detector is not less than the first value and not more than the second value at a time of detection of fluorescence by the fluorescence detector, may cause the lamp driver to stop the lighting work for the discharge lamp.

In this case, damage to the discharge lamp due to continuous use of the discharge lamp satisfying the first deterioration condition is prevented.

(Item 5) The lamp lighting device according to item 4, may further include a signal outputter that outputs a notification signal relating to deterioration of the discharge lamp, wherein the storage may further store a third value larger than the second value, the third value may be a value corresponding to a lamp voltage detected by the lamp-voltage detector when a sample discharge lamp satisfying a second deterioration condition is lit before detection of fluorescence by the fluorescence detector, with the second deterioration condition representing that a deterioration degree of a discharge lamp is in a second range larger than the first range, the deterioration determiner may determine which one of the first value, the second value and the third value a lamp-voltage value detected by the lamp-voltage detector at a time of detection of fluorescence by the fluorescence detector is closest to, and the signal outputter, in a case in which a lamp-voltage value detected by the lamp-voltage detector is closest to the second value, may output a notification signal indicating that a deterioration degree of a discharge lamp is in the first range, and in a case in which a lamp-voltage value detected by the lamp-voltage detector is closest to the third value, may output a notification signal indicating that a deterioration degree of a discharge lamp is in the second range.

In this case, the deterioration degree of the discharge lamp is presented to the user. Therefore, the user can easily and appropriately identify whether the discharge lamp needs to be replaced.

(Item 6) The lamp lighting device according to item 1 or 2, may further include a storage that stores a first value, a second value larger than the first value and a third value larger than the second value, and a signal outputter that outputs a notification signal relating to deterioration of the discharge lamp, wherein the first value may be a value corresponding to a lamp voltage detected by the lamp-voltage detector when an unused sample discharge lamp is lit before detection of fluorescence by the fluorescence detector, the second value may be a value corresponding to a lamp voltage detected by the lamp-voltage detector when a sample discharge lamp satisfying a first deterioration condition is lit before detection of fluorescence by the fluorescence detector, with the first deterioration condition representing that a deterioration degree of a discharge lamp is in a predetermined first range, and the third value may be a value corresponding to a lamp voltage detected by the lamp-voltage detector when a sample discharge lamp satisfying a second deterioration condition is lit before detection of fluorescence by the fluorescence detector, with the second deterioration condition representing that a deterioration degree of a discharge lamp is in a second range larger than the first range, the deterioration determiner may determine which one of the first value, the second value and the third value a lamp-voltage value detected by the lamp-voltage detector at a time of detection of fluorescence by the fluorescence detector is closest to, and the signal outputter, in a case in which a lamp-voltage value detected by the lamp-voltage detector is closest to the second value, may output a notification signal indicating that a deterioration degree of a discharge lamp is in the first range, and in a case in which a lamp-voltage value detected by the lamp-voltage detector is closest to the third value, may output a notification signal indicating that a deterioration degree of a discharge lamp is in the second range.

In this case, the deterioration degree of the discharge lamp is presented to the user. Therefore, the user can easily and appropriately identify whether the discharge lamp needs to be replaced.

(Item 7) The lamp lighting device according to item 1 or 2, may further include a storage storing a fourth value and a fifth value larger than the fourth value, a calculator that performs calculation relating to the lamp voltage, and a driving controller that controls work of the lamp driver, wherein the lamp-voltage detector may further detect a lamp voltage when the discharge state is in the stable state, the calculator may calculate a difference value between a lamp voltage detected by the lamp-voltage detector in the monitoring period and a lamp voltage detected by the lamp-voltage detector when the discharge state is in the stable state, the fourth value may be a value corresponding to a lamp difference value calculated by the calculator when an unused sample discharge lamp is lit before detection of fluorescence by the fluorescence detector, the fifth value may be a value corresponding to a lamp difference value calculated by the calculator when a sample discharge lamp satisfying a first deterioration condition is lit before detection of fluorescence by the fluorescence detector, with the first deterioration condition representing that a deterioration degree of a discharge lamp is in a predetermined first range, the deterioration determiner may determine whether a lamp difference value calculated by the calculator at a time of detection of fluorescence by the fluorescence detector is not less than the fourth value and not more than the fifth value, and the driving controller, in a case in which a lamp difference value calculated by the calculator at a time of detection of fluorescence by the fluorescence detector is not less than the fourth value and not more than the fifth value, may allow the lamp driver to perform lighting work for the discharge lamp, and in a case in which a lamp difference value calculated by the calculator at a time of detection of fluorescence by the fluorescence detector is not less than the fourth value and not more than the fifth value, may cause the lamp driver to stop the lighting work for the discharge lamp.

In this case, damage to the discharge lamp due to continuous use of the discharge lamp satisfying the first deterioration condition is prevented.

(Item 8) The lamp lighting device according to item 7, may further include a signal outputter that outputs a notification signal relating to deterioration of the discharge lamp, wherein the storage further may store a sixth value larger than the fifth value, the sixth value may be a value corresponding to a lamp difference value calculated by the calculator when a sample discharge lamp satisfying a second deterioration condition is lit before detection of fluorescence by the fluorescence detector, with a second deterioration condition representing that a deterioration degree of a discharge lamp is in a second range larger than the first range, the deterioration determiner may determine which one of the fourth value, the fifth value and the sixth value a lamp difference value calculated by the calculator at a time of detection of fluorescence by the fluorescence detector is closest to, and the signal outputter, in a case in which a lamp difference value calculated by the calculator is closest to the fifth value, may output a notification signal indicating that a deterioration degree of a discharge lamp is in the first range, and in a case in which a lamp difference value calculated by the calculator is closest to the sixth value, may output a notification signal indicating that a deterioration degree of a discharge lamp is in the second range.

In this case, the deterioration degree of the discharge lamp is presented to the user. Therefore, the user can easily and appropriately identify whether the discharge lamp needs to be replaced.

(Item 9) The lamp lighting device according to item 1, may further include a storage that stores a fourth value, a fifth value larger than the fourth value, and a sixth value larger than the fifth value, and a calculator that performs calculation relating to the lamp voltage, and a signal outputter that outputs a notification signal relating to deterioration of the discharge lamp, wherein the lamp-voltage detector may further detect a lamp voltage when the discharge state is in the stable state, the calculator may calculate a difference value between a lamp voltage detected by the lamp-voltage detector in the monitoring period and a lamp voltage detected by the lamp-voltage detector when the discharge state is in the stable state, the fourth value may be a value corresponding to a lamp difference value calculated by the calculator when an unused sample discharge lamp is lit before detection of fluorescence by the fluorescence detector, the fifth value may be a value corresponding to a lamp difference value calculated by the calculator when a sample discharge lamp satisfying a first deterioration condition is lit before detection of fluorescence by the fluorescence detector, with the first deterioration condition representing that a deterioration degree of a discharge lamp is in a predetermined first range, the sixth value may be a value corresponding to a lamp difference value calculated by the calculator when a sample discharge lamp satisfying a second deterioration condition is lit before detection of fluorescence by the fluorescence detector, with the second deterioration condition representing that a deterioration degree of a discharge lamp is in a second range larger than the first range, the deterioration determiner may determine which one of the fourth value, the fifth value and the sixth value a lamp difference value calculated by the calculator at a time of detection of fluorescence by the fluorescence detector is closest to, and the signal outputter, in a case in which a lamp difference value calculated by the calculator is closest to the fifth value, may output a notification signal indicating that a deterioration degree of a discharge lamp is in the first range, and in a case in which a lamp difference value calculated by the calculator is closest to the sixth value, may output a notification signal indicating that a deterioration degree of a discharge lamp is in the second range.

In this case, the deterioration degree of the discharge lamp is presented to the user. Therefore, the user can easily and appropriately identify whether the discharge lamp needs to be replaced.

(Item 10) A fluorescence detector according to another aspect, may include the lamp lighting device according to any one of items 1 to 9, an optical system that guides light generated by the lamp lighting device as excitation light, and a light receiver that detects an intensity of fluorescence by receiving fluorescence generated from the sample.

With the lamp lighting device 200 according to any one of items 1 to 9, it is possible to appropriately determine whether the discharge lamp in the fluorescence detector needs to be replaced. Therefore, because the discharge lamp can be appropriately replaced, a decrease in accuracy for detection of fluorescence due to continuous use of the deteriorated discharge lamp is suppressed.

(Item 11) A chromatograph according to another aspect may include a sample introducer that introduces a sample into an analysis flow path through which a mobile phase flows, a separation column that separates a sample that has been introduced into the analysis flow path by the sample introducer into components, and a detector for detecting sample components into which a sample has been separated by the separation column, wherein the detector may include the fluorescence detector according to item 10.

With the fluorescence detector according to item 9, a decrease in accuracy for detection of fluorescence due to continuous use of the deteriorated discharge lamp is suppressed. Thus, a reduction in accuracy for detection of a sample caused by the discharge lamp in the liquid chromatograph is suppressed.

1. A lamp lighting device for a discharge lamp, the lamp lighting device being provided as a light source in a fluorescence detector, wherein
the discharge lamp has a configuration in which an anode and a cathode are arranged to be opposite to each other in a discharge container, and
the lamp lighting device includes
a lamp driver that drives the discharge lamp,
a lamp-voltage detector that detects a voltage between the anode and the cathode as a lamp voltage in a monitoring period until a discharge state between the anode and the cathode reaches a predetermined stable state after the discharge lamp in an unlit state due to driving of the lamp driver is lit by electrical breakdown between the anode and cathode, and
a deterioration determiner that determines a deterioration state of the discharge lamp based on a lamp voltage detected by the lamp-voltage detector.

2. The lamp lighting device according to claim 1, wherein
the stable state is a discharge state when an absolute value of a change amount per unit time of the lamp voltages is equal to or smaller than a predetermined change-rate threshold value or when the lamp voltage is continuously in a predetermined stable determination range in a predetermined stable determination period of time.

3. The lamp lighting device according to claim 1, further comprising:
a storage that stores a first value and a second value larger than the first value; and
a driving controller that controls work of the lamp driver, wherein
the first value is a value corresponding to a lamp voltage detected by the lamp-voltage detector when an unused sample discharge lamp is lit before detection of fluorescence by the fluorescence detector,
the second value is a value corresponding to a lamp voltage detected by the lamp-voltage detector when a sample discharge lamp satisfying a first deterioration condition is lit before detection of fluorescence by the fluorescence detector, with the first deterioration condition representing that a deterioration degree of a discharge lamp is in a predetermined first range, and
the deterioration determiner determines that, when a lamp-voltage value detected by the lamp-voltage detector is not less than the first value and not more than the second value at a time of detection of fluorescence by the fluorescence detector, a deterioration degree of the discharge lamp has not reached a degree at which replacement is required.

4. The lamp lighting device according to claim 3, wherein
the driving controller,
in a case in which a lamp-voltage value detected by the lamp-voltage detector is not less than the first value and not more than the second value at a time of detection of fluorescence by the fluorescence detector, allows the lamp driver to perform lighting work for the discharge lamp, and
in a case in which a lamp-voltage value detected by the lamp-voltage detector is not less than the first value and not more than the second value at a time of detection of fluorescence by the fluorescence detector, causes the lamp driver to stop the lighting work for the discharge lamp.

5. The lamp lighting device according to claim 4, further comprising a signal outputter that outputs a notification signal relating to deterioration of the discharge lamp, wherein
the storage further stores a third value larger than the second value,
the third value is a value corresponding to a lamp voltage detected by the lamp-voltage detector when a sample discharge lamp satisfying a second deterioration condition is lit before detection of fluorescence by the fluorescence detector, with the second deterioration condition representing that a deterioration degree of a discharge lamp is in a second range larger than the first range,
the deterioration determiner determines which one of the first value, the second value and the third value a lamp-voltage value detected by the lamp-voltage detector at a time of detection of fluorescence by the fluorescence detector is closest to, and
the signal outputter,
in a case in which a lamp-voltage value detected by the lamp-voltage detector is closest to the second value, outputs a notification signal indicating that a deterioration degree of a discharge lamp is in the first range, and
in a case in which a lamp-voltage value detected by the lamp-voltage detector is closest to the third value, outputs a notification signal indicating that a deterioration degree of a discharge lamp is in the second range.

6. The lamp lighting device according to claim 1, further comprising:
a storage that stores a first value, a second value larger than the first value and a third value larger than the second value; and
a signal outputter that outputs a notification signal relating to deterioration of the discharge lamp, wherein
the first value is a value corresponding to a lamp voltage detected by the lamp-voltage detector when an unused sample discharge lamp is lit before detection of fluorescence by the fluorescence detector,
the second value is a value corresponding to a lamp voltage detected by the lamp-voltage detector when a sample discharge lamp satisfying a first deterioration condition is lit before detection of fluorescence by the fluorescence detector, with the first deterioration condition representing that a deterioration degree of a discharge lamp is in a predetermined first range,
the third value is a value corresponding to a lamp voltage detected by the lamp-voltage detector when a sample discharge lamp satisfying a second deterioration condition is lit before detection of fluorescence by the fluorescence detector, with the second deterioration condition representing that a deterioration degree of a discharge lamp is in a second range larger than the first range,
the deterioration determiner determines which one of the first value, the second value and the third value a lamp-voltage value detected by the lamp-voltage detector at a time of detection of fluorescence by the fluorescence detector is closest to, and
the signal outputter,
in a case in which a lamp-voltage value detected by the lamp-voltage detector is closest to the second value, outputs a notification signal indicating that a deterioration degree of a discharge lamp is in the first range, and
in a case in which a lamp-voltage value detected by the lamp-voltage detector is closest to the third value, outputs a notification signal indicating that a deterioration degree of a discharge lamp is in the second range.

7. The lamp lighting device according to claim 1, further comprising:
a storage storing a fourth value and a fifth value larger than the fourth value;
a calculator that performs calculation relating to the lamp voltage; and
a driving controller that controls work of the lamp driver, wherein
the lamp-voltage detector further detects a lamp voltage when the discharge state is in the stable state,
the calculator calculates a difference value between a lamp voltage detected by the lamp-voltage detector in the monitoring period and a lamp voltage detected by the lamp-voltage detector when the discharge state is in the stable state,
the fourth value is a value corresponding to a lamp difference value calculated by the calculator when an unused sample discharge lamp is lit before detection of fluorescence by the fluorescence detector,
the fifth value is a value corresponding to a lamp difference value calculated by the calculator when a sample discharge lamp satisfying a first deterioration condition is lit before detection of fluorescence by the fluorescence detector, with the first deterioration condition representing that a deterioration degree of a discharge lamp is in a predetermined first range,
the deterioration determiner determines whether a lamp difference value calculated by the calculator at a time of detection of fluorescence by the fluorescence detector is not less than the fourth value and not more than the fifth value, and
the driving controller,
in a case in which a lamp difference value calculated by the calculator at a time of detection of fluorescence by the fluorescence detector is not less than the fourth value and not more than the fifth value, allows the lamp driver to perform lighting work for the discharge lamp, and
in a case in which a lamp difference value calculated by the calculator at a time of detection of fluorescence by the fluorescence detector is not less than the fourth value and not more than the fifth value, causes the lamp driver to stop the lighting work for the discharge lamp.

8. The lamp lighting device according to claim 7, further comprising a signal outputter that outputs a notification signal relating to deterioration of the discharge lamp, wherein
the storage further stores a sixth value larger than the fifth value,
the sixth value is a value corresponding to a lamp difference value calculated by the calculator when a sample discharge lamp satisfying a second deterioration condition is lit before detection of fluorescence by the fluorescence detector, with a second deterioration condition representing that a deterioration degree of a discharge lamp is in a second range larger than the first range,
the deterioration determiner determines which one of the fourth value, the fifth value and the sixth value a lamp difference value calculated by the calculator at a time of detection of fluorescence by the fluorescence detector is closest to, and
the signal outputter,
in a case in which a lamp difference value calculated by the calculator is closest to the fifth value, outputs a notification signal indicating that a deterioration degree of a discharge lamp is in the first range, and
in a case in which a lamp difference value calculated by the calculator is closest to the sixth value, outputs a notification signal indicating that a deterioration degree of a discharge lamp is in the second range.

9. The lamp lighting device according to claim 1, further comprising:
a storage that stores a fourth value, a fifth value larger than the fourth value, and a sixth value larger than the fifth value;
a calculator that performs calculation relating to the lamp voltage; and
a signal outputter that outputs a notification signal relating to deterioration of the discharge lamp, wherein
the lamp-voltage detector further detects a lamp voltage when the discharge state is in the stable state,
the calculator calculates a difference value between a lamp voltage detected by the lamp-voltage detector in the monitoring period and a lamp voltage detected by the lamp-voltage detector when the discharge state is in the stable state,
the fourth value is a value corresponding to a lamp difference value calculated by the calculator when an unused sample discharge lamp is lit before detection of fluorescence by the fluorescence detector,
the fifth value is a value corresponding to a lamp difference value calculated by the calculator when a sample discharge lamp satisfying a first deterioration condition is lit before detection of fluorescence by the fluorescence detector, with the first deterioration condition representing that a deterioration degree of a discharge lamp is in a predetermined first range,
the sixth value is a value corresponding to a lamp difference value calculated by the calculator when a sample discharge lamp satisfying a second deterioration condition is lit before detection of fluorescence by the fluorescence detector, with the second deterioration condition representing that a deterioration degree of a discharge lamp is in a second range larger than the first range,
the deterioration determiner determines which one of the fourth value, the fifth value and the sixth value a lamp difference value calculated by the calculator at a time of detection of fluorescence by the fluorescence detector is closest to, and
the signal outputter,
in a case in which a lamp difference value calculated by the calculator is closest to the fifth value, outputs a notification signal indicating that a deterioration degree of a discharge lamp is in the first range, and
in a case in which a lamp difference value calculated by the calculator is closest to the sixth value, outputs a notification signal indicating that a deterioration degree of a discharge lamp is in the second range.

10. A fluorescence detector, including:
the lamp lighting device according to claim 1;
an optical system that guides light generated by the lamp lighting device as excitation light; and
a light receiver that detects an intensity of fluorescence by receiving fluorescence generated from the sample.

11. A chromatograph comprising:
a sample introducer that introduces a sample into an analysis flow path through which a mobile phase flows;
a separation column that separates a sample that has been introduced into the analysis flow path by the sample introducer into components; and
a detector for detecting sample components into which a sample has been separated by the separation column, wherein
the detector includes the fluorescence detector according to claim 10.
